(19) United States
(12) Patent Application Publication
(10) Pub. No.: US 2005/0278967 A1
(43) Pub. Date: Dec. 22, 2005

(54) Measuring towel

(76) Inventor: Christoffel Johannes Du Plessis, Bloemfontein (ZA)

Correspondence Address: H. Roy Berkenstock;Wyatt, Tarrant & Combs, LLP, Suite 800, 1715 Aaron Brennar Dr., Memphis, TN, 38120-4367, US

(21) Appl. No.: 11/211,247

(22) Filed: Aug. 17, 2005

(30) Foreign Application Priority Data
Feb. 19, 2003 (ZA) 2003/1340

(51) Int. Cl. B43L 7/00

(52) U.S. Cl. 33/493

(57) ABSTRACT

a multi-function item of bodily use in the form of a measuring towel (10) of a cloth type material in the form of a conventional towel (12) including measuring means as by one or more measuring strips or tapes (14) having regular markings of any known measuring system. the towel (12) of the preferred embodiment includes two measuring strips (3.1 and 14.2) in the form of measuring tapes extending along the towel edge (12.1 and 12.3). The strips (14) can be integrally formed with the towel during the manufacture or be secured to a manufactured towel. The towel (10) is thus useable to measure appropriate body measurements such as the waistline, length of a limb or another desired measurement of a person. Measurement may be made simply by holding towel (12) against the body and lengthwise or circumferentially fitting along or around the location where the bodily measurement is desired, such that the measuring strip (14) runs closely along the distance to be measured.

### CROSS REFERENCE TO RELATED APPLICATIONS

This application claims priority of PCT/ZA2004/000014 filed Feb. 19, 2004, which claims priority of ZA 2003/1340 filed Feb. 19, 2003.

### STATEMENT REGARDING SPONSORED RESEARCH OR DEVELOPMENT

Not applicable

### REFERENCE TO A MICROFICHE APPENDIX

Not applicable

### FIELD OF THE INVENTION

This invention relates to a multi-functional item of bodily use associated fabric material. Although not so limited the invention finds useful application when in the form of a towel also providing for the taking of body measurements.

### BACKGROUND TO THE INVENTION

The taking of body contour following measurements such as the waistline of a person is normally done by a measuring tape. For accurate measuring the measurements must taken while the person so involved is appropriately undressed. This often created a nuisance as it requires the specific step of undressing and often beforehand searching for a tape. It will thus be useful to have measuring means available at an instant when a person is in the normal course of events undressed while requiring the use of some or other bodily use related fabric type item such as a towel.

### FIELD OF THE INVENTION

This invention relates to a multi-function item of bodily use associated fabric material. Although not so limited the invention finds useful application when in the form of a towel also providing for the taking of body measurements.

### PRIOR ART DESCRIPTION

The steps of bodily toweling and of taking body measurements is in the normal course of events dealt with by separate items being on the one hand, a towel and, on the other hand, a measuring tape. A disadvantage in using separate items in performing such operations is that the measuring tape is often not when a person is suitably undressed to take accurate body measurements, such as for example when drying one's body after a bath or shower. It is, amongst others, an object of this invention to overcome this disadvantage. It will, however, become clear that the invention in not limited to only such use.

### BRIEF DESCRIPTION OF THE DRAWING

FIG. 1 is a plan view of the present invention in a rectangular shape with measuring indicia on two borders.

FIG. 2 is a plan view of an alternative embodiment of the invention of FIG. 1 wherein the sides are oblique and the measuring indicia on the diagonal.

### DETAILED DESCRIPTION OF THE PREFERRED EMBODIMENTS

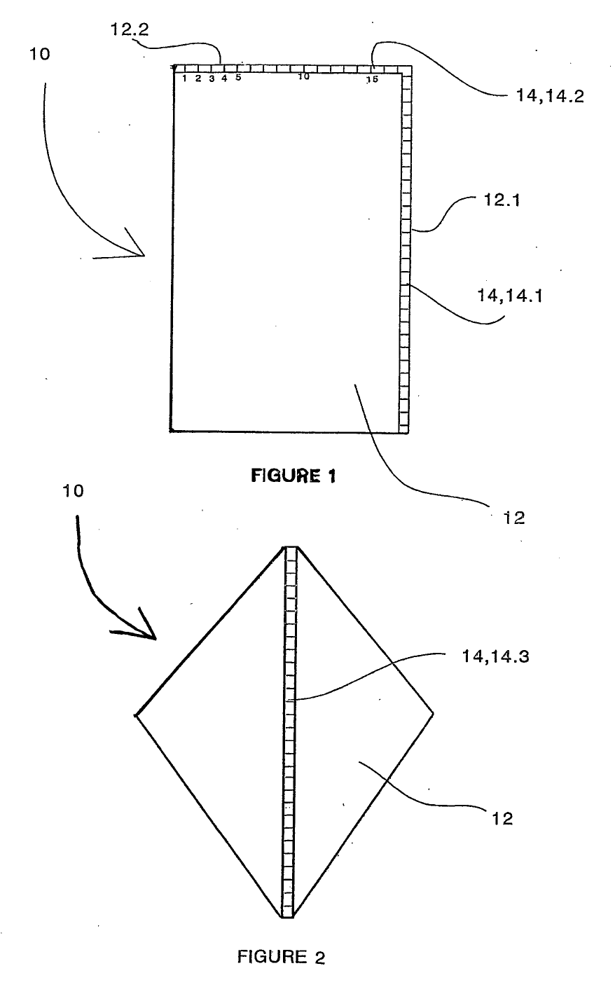

Referring to the drawings, a multi-function item of bodily use, according to the invention, in the form of a measuring towel is generally indicated by reference numeral 10. Referring to FIG. 1, the measuring towel 10 comprises a cloth type article in the form of a conventional towel 12 presenting measuring means as provided by one or more measuring strips 14 presenting measurement indication markings according to any known measuring system. The markings are in the form of for example, letters, figures, words, lines, colors, graphic representations, or any combination thereof as representing metric and/or imperial measuring dimensions. Referring in particular to FIG. 1 the towel 12 presents two measuring strips 14.1 and 14.2, in the form of measuring tapes extending along contiguous end on extending towel edges 12.1 and 12.2. The strips 14.1 and 14.2 can be integrally formed with the towel during its manufacturing. Alternatively the strips 14.1, 14.2 can be secured to a pre-manufactured towel by way of, for example, stitching, adhesive securing, zipping, pinning, laminating, embroidering, printing and/or writing.

While only the one side of the towel 12 is visible in FIG. 1 the strips 14.1, 14.2 can be arranged to result in the provision of measuring means along opposite sides of the appropriate edges of the towel 12.

Referring to FIG. 2 and in another embodiment the measuring strip 14.3 is presented to diagonally extend across the towel 12. The strip 14. 3 can, similar to the FIG. 1 embodiment, be integrally formed with or secured to the towel 12 and can also extend along opposite towel sides. Although not shown the measuring towel 10 can incorporate marking means such as a pen, pencil or clips for indicating body measurement on the towel 12 and/or on an appropriate measuring strip 14. The pen or pencil can be of a kind of which the markings made on the towel 12 or strip (s) 14 are removable by for example being washable. The clips when removable can have variety of colors ; different colors thus being conveniently employable for the measurement of different body parts.

The measuring towel 10 is thus employable to measure appropriate body measurements such as the waistline, hips, breast, length or any other desired measurement of a person. As the given body dimensions can serve as an indication of bodily weight or, in the case of a baby or youngster, length, the measuring towel 10 can be effortlessly employed to keep track of the latter during an appropriate phase. The measurements can, for example, be taken at regular intervals and be plotted on a graph or even by markings on the towel 12 or on the marking strip (s) 14 thereby serving as accurate indication of the growing process of a youngster or the success in following a dieting or even a muscle building program. The possible applications given are naturally only examples of the use of the measuring towel 10.

In use the measuring towel 10 is thus simply held against or circumferentially fitted around the location where bodily measurement is desired to be established in a way that causes the or an appropriate measuring strip 14 to run closely alongside the body. The appropriate measurements are thus simply read off from the measuring strip 14.

It is an advantage of this invention that a conventional item of bodily use is suitably supplemented to enable it to also perform a secondary function that in the appropriate case ties in with its circumstances of primary use.

1) A multi-function item (10) of bodily use associated fabric material comprising at least one cloth type article (12) having a primary bodily use associated function characterized in that the article presents measuring means (14) employable for physically measuring at least a related bodily measurable characteristic in response to the appropriate manually manipulative positioning of the article relative to such body even if requiring the re- arrangement of the article from a condition of conventional bodily application, the article (12) of necessity being of a suitable conformation to enable the effective use of the measuring means:

2) An item as claimed in claim 1 in which the measuring means is in the form of a dimensional measurer (14) for enabling the non-primary application of the article in measuring at least dimension related bodily characteristics.

3) An item as claimed in claim 2 in which the dimensional measurer is in the form of at least one appropriately marked measuring strip (14) extending suitably along the article (12) to enable its effective application in measuring linear bodily measurements or linear measurement related bodily characteristics.

4) An item as claimed in claim 3 in which the measuring strip (14) is integrally formed with the article.

5) An item as claimed in claim 3 in which the measuring strip (14) is appropriately secured to the article.

6) An item as claimed in claim 5 in which the measuring strip (14) extends in the form of a measuring tape.

7) An item as claimed in claim 2 in which the article (12) presents at least one linearly extending edge along at least one side of which the at least one measuring strip (14).

8) An item as claimed in 7 in which the article (12) is of multi-sided outline profile.

9) An item as claimed in claim 8 in which the article (12) presents at least two measuring strips (14,14.1, 14.2) extending along end on contiguous article edges (12.1, 12.2).

10) An item as claimed in claim 8 in which the article presents a measuring strip (14,14.3) extending between two non-adjacent article corners as thus being of appropriate multi-sided outline profile.

11) An item as claimed in claim 8 in which the article (12) is of rectangular outline profile.

12) An item as claimed in claim 3 that includes marking means for indicating body measurements on one of the towel and the relevant measuring strip.

13) An item as claimed in claim 12 in which the marking means is in the form of a writing instrument.

14) An item as claimed in claim 12 in which the making means is in the form of clips that are removably securable to the towel.

15) An item as claimed in claim 1 in which the article (12) is of a sheet material for non-human use.

16) An item as claimed in claim 1 in which the article (12) is of absorbent cloth.

17) An item as claimed in claim 16 in which the article is in the form of a towel (12).
